(19) United States
(12) Patent Application Publication
(10) Pub. No.: US 2004/0089117 A1
(43) Pub. Date: May 13, 2004

(54) Pliers with pivotable jaws

(76) Inventor: Shih-Kuei Hsien, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/289,251

(22) Filed: Nov. 7, 2002

(51) Int. Cl. B25B 7/02

(52) U.S. Cl. 81/424

(57) ABSTRACT

A pair of pliers includes two handles each have a hole defined in an end thereof and a pin is received in the two holes to connect the two handles. A connection port is connected to the end of each of the two handles and two jaws are pivotably connected to the two connection ports respectively. The jaws are able to be pivoted an angle relative to the handles so as to access an object in a narrow space.

### FIELD OF THE INVENTION

The present invention relates to a pair of pliers which has two jaws and each jaw is pivotably connected to the handles so as to be positioned at desired angle.

### BACKGROUND OF THE INVENTION

A conventional pair of pliers 10 is shown in FIG. 1 and generally includes two handles 14 which are pivotably connected with each other at an end, and two jaws 12 respectively extend from the two handles 14. The two jaws 12 are located at the same plane as the handles 14 so that when the pliers is used in a narrow space as shown in FIG. 1, the handles 14 are jammed or stocked by objects beside the screw that the jaws 12 are to be accessed. Referring to FIGS. 2 to 4, in order to improve the inconvenience, the handles 16 are made to be operated at a plane that is different from the plane where the jaws 15. This type of pliers has long handles so that they can be made as angled handles and are convenient to be use. The long handles limit the space that the pliers can be rotatably used.

The present invention intends to provide pliers that has pivotable jaws so that the pliers can be set at a specific angle to access an object that is located in a narrow space.

### SUMMARY OF THE INVENTION

In accordance with one aspect of the present invention, there is provided a pair of pliers which comprises two handles each have a hole defined in an end thereof and a pin is received in the two holes. A connection port is connected to the end of each of the two handles so as to respectively and pivotably connect two jaws.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a conventional pliers are jammed by objects beside the screw to be accessed;

FIGS. 2 to 4 show different types of conventional pliers;

FIG. 5 is an exploded view to show the pliers of the present invention;

FIG. 6 is a perspective view to show the pliers of the present invention;

FIG. 7 shows the jaws are pivoted to access a screw;

FIG. 8 is an exploded view to show another embodiment of the pliers of the present invention;

FIGS. 9 and 10 show the engagement of a bead and one of the notches of the jaws at two positions of the jaws;

FIG. 11 is a perspective view to show that the each jaw of the pliers has two sections;

FIG. 12 is a plane view to show the pliers as shown in FIG. 11;

FIGS. 13 and 14 show the sections of the jaws of the pliers as shown in FIG. 11 are pivoted.

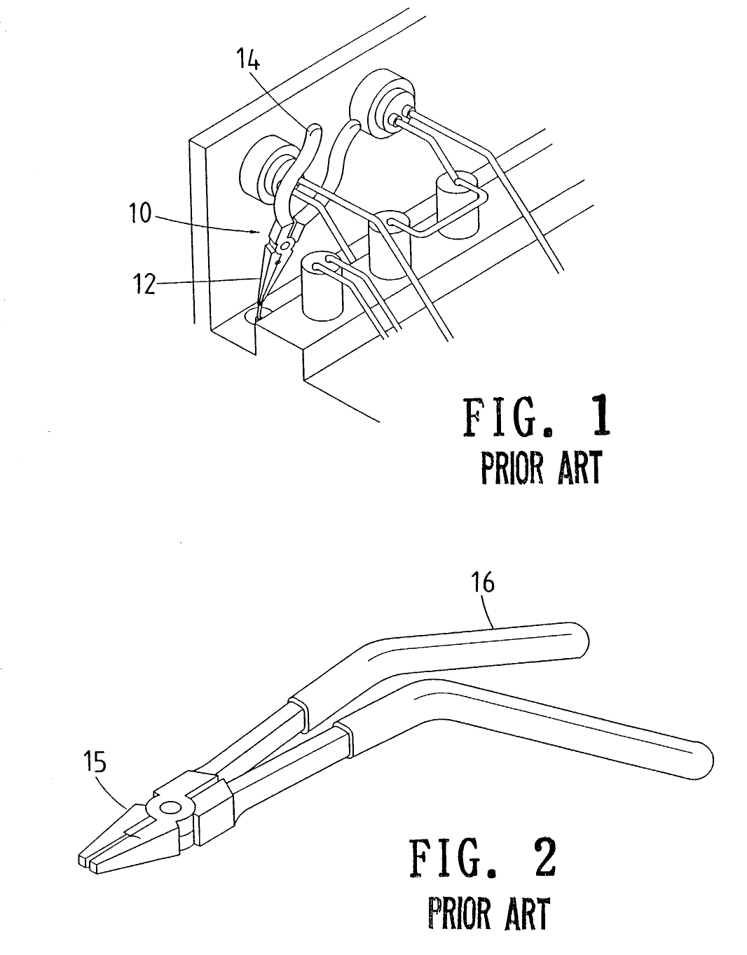

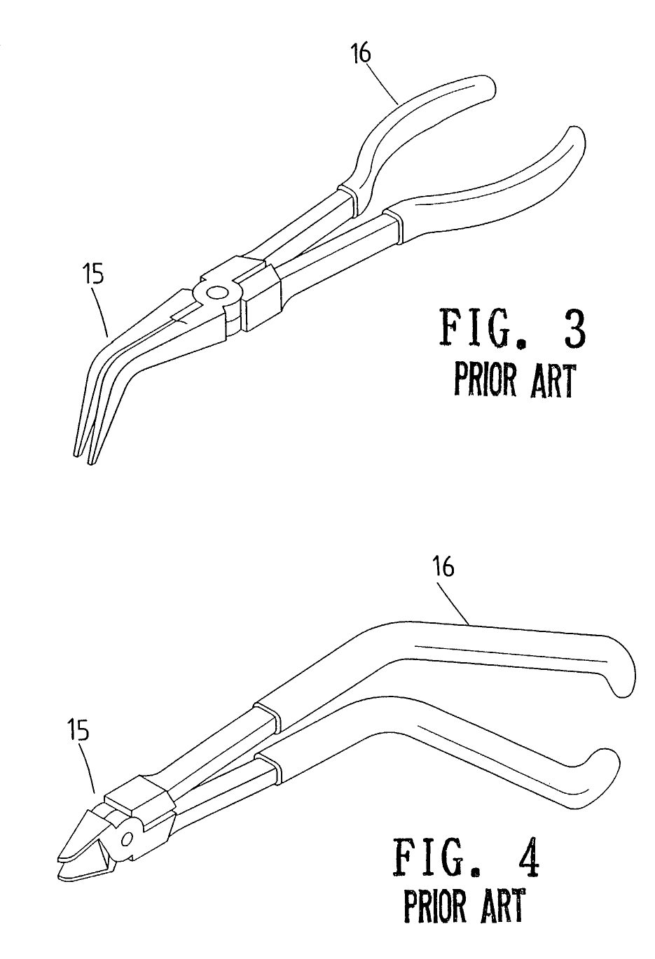

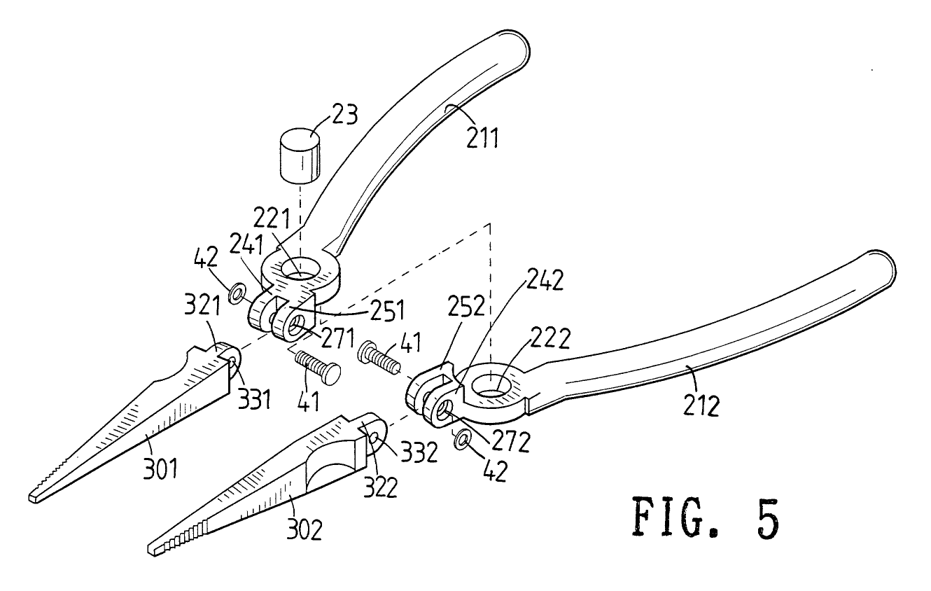

### DETAILED DESCRIPTION OF THE PREFERRED EMBODIMENTS

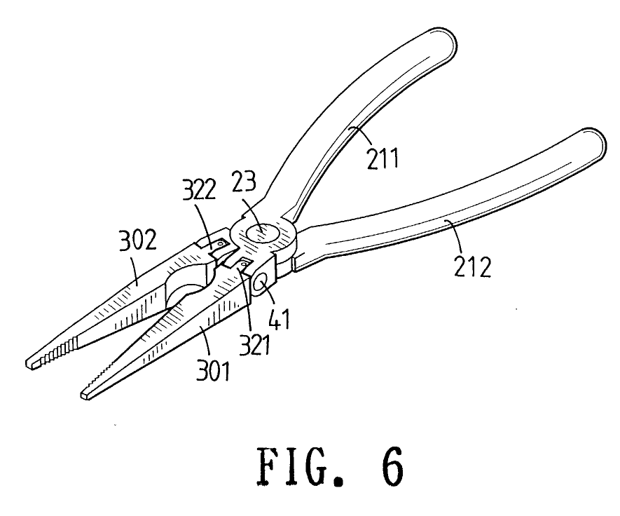

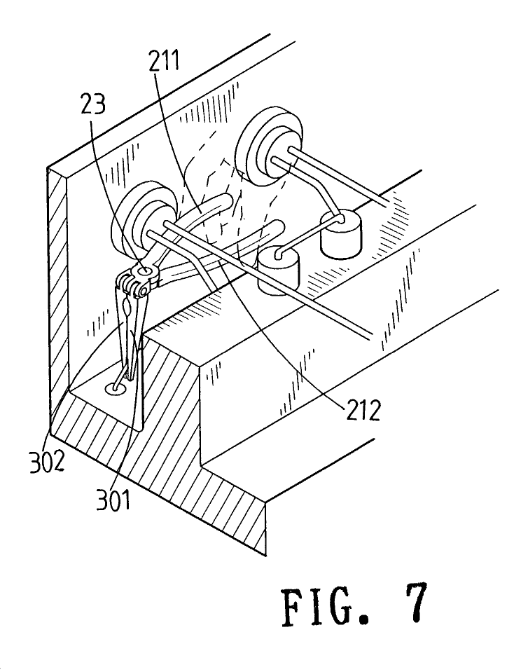

Referring to FIGS. 5 to 7, the pliers of the present invention comprises a two handles 211, 212 each having a hole 221/222 defined in an end thereof and a pin 23 is received in the two holes 221, 222 so that the two handles 211, 212 are pivotably connected with each other. A connection port 241/242 is connected to the end of each of the two handles 211, 212 and each connection port 241/242 includes two lugs 251, 252. Each lug 251/252 has a hole 271/272 defined therethrough.

Two jaws 301, 302 each include a protrusion 321/322 which is pivotably connected between the two lugs 251/252 corresponding to the protrusion 321/322 by extending a screw 41 through the holes 271, 272 in the lugs 251, 252 and holes 331, 332 in the two protrusions 321, 322, and cooperated with a nut 42.

The two jaws 301, 302 are pivoted to a desired angle relative to the handles 211, 212 so that the two handles 211, 212 are not jammed by objects besides the screw to be clamped by the jaws 301, 302.

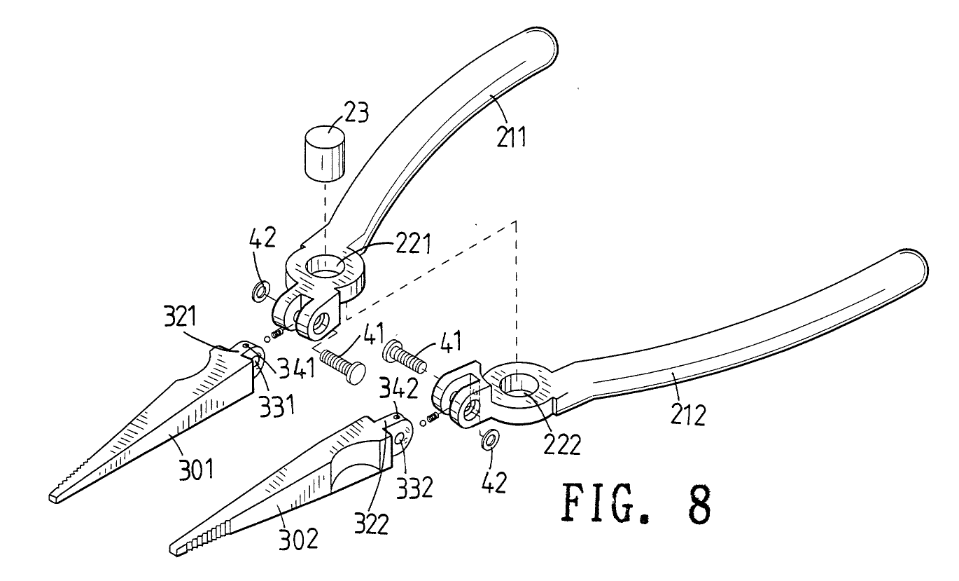

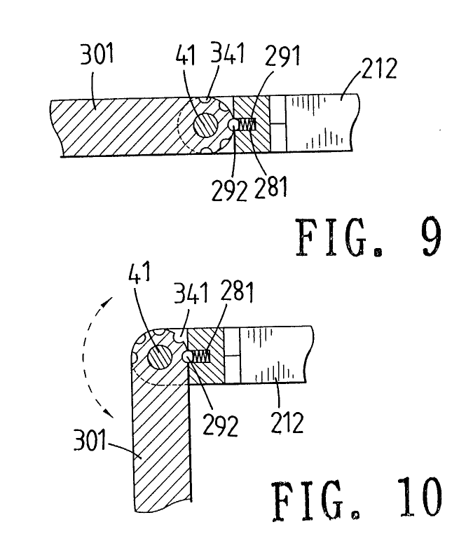

Referring to FIGS. 8 to 10, each protrusion 321/322 has a plurality of notches 341/342 defined in an outside thereof and each handle 211/212 has a recess 281 defined therein in which a bead 292 and a spring 291 are received. The bead 292 is engaged with one of the notches 341/342 in the protrusion corresponding thereto. The engagement of the beads 292 and the notches 341/342 ensures the position of the jaws 301, 302 that are pivoted.

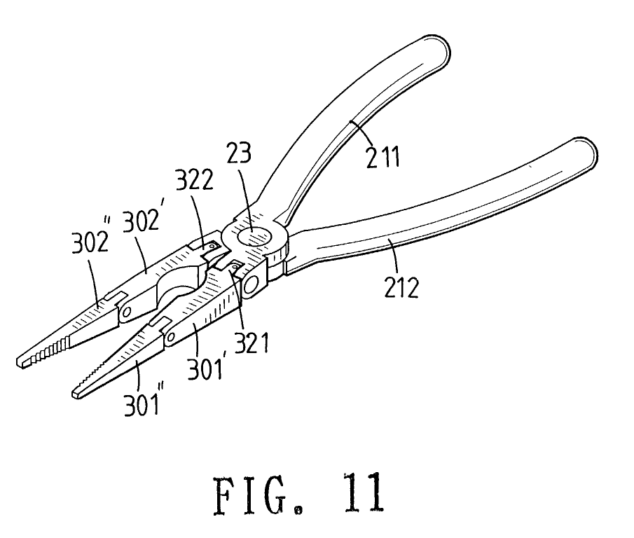

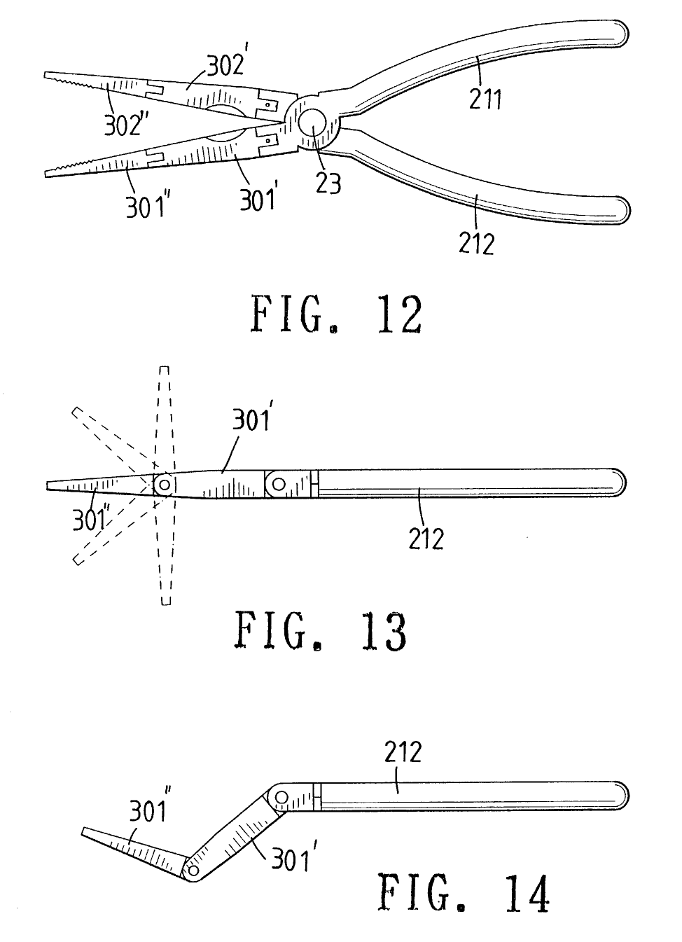

FIGS. 11 to 14 show that each jaw includes two sections 301′, 301″/302′, 302″ which are pivotably connected with each other by the same structure as the connection between the jaws and the handles illustrated in FIG. 5 or 8. The two sections 301′, 301″/302′, 302″ can be pivoted independently from each other such that the jaws are used in different ways.

While we have shown and described the embodiment in accordance with the present invention, it should be clear to those skilled in the art that further embodiments may be made without departing from the scope of the present invention.

What is claimed is:

1. A pair of pliers comprising:
two handles each having a hole defined in an end thereof and a pin received in the two holes, and
a connection port connected to the end of each of the two handles and two jaws are pivotably connected to the two connection ports respectively.

2. The pliers as claimed in claim 1, wherein each connection port includes two lugs and each jaw has a protrusion which is pivotably connected between the two lugs corresponding to the protrusion.

3. The pliers as claimed in claim 2, wherein each protrusion has a plurality of notches defined in an outside thereof and each handle has a recess defined therein in which a bead and a spring are received, the bead engaged with one of the notches.

4. The pliers as claimed in claim 1, wherein each jaw includes two sections which are pivotably connected with each other.
